(19) United States
(12) Patent Application Publication
(10) Pub. No.: US 2008/0056065 A1
(43) Pub. Date: Mar. 6, 2008

(54) Static Mixer

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: MEDMIX SYSTEMS AG, CH-6343 ROTKREUZ (CH)

(21) Appl. No.: 11/663,755

(22) PCT Filed: Oct. 11, 2005
(86) PCT No.: PCT/CH05/00593

§ 371 Date: Mar. 26, 2007

(30) Foreign Application Priority Data
Oct. 15, 2004 (CH) 2004 1707/04

(51) Int. Cl. B01F 9/16

(52) U.S. Cl. 366/339

(57) ABSTRACT

The static mixer for two components comprises a housing with an inlet section and mixing elements that are arranged in the housing. At least one of the mixing elements is designed, in contrast to mixing helixes of the prior art, as a disk-shaped shear plate having a passage in its disk. Such shear elements allow mixing even of smallest quantities that are possibly dispensed drop by drop, as higher shearing rates are produced near the passages of the shear plates during dispensing and vortices are created on their outlet sides. This is very advantageous especially in medical applications of such mixers.

### CROSS-REFERENCE TO RELATED APPLICATION

This application is the National Phase of International Application No. PCT/CH2005/000593, filed Oct. 11, 2005, and published as WO 2006/039827, which in turn claims priority to Switzerland Application No. 2004 1707/04, the contents of these applications are herein incorporated by reference.

### FIELD OF INVENTION

The present invention relates to a static mixer for two components, comprising an inlet section and a housing with mixing elements arranged therein, of which at least one mixing element is a mixing helix.

### BACKGROUND OF THE INVENTION

Mixing two substances by means of a static mixer has been known for a very long time, and the large majority of the static mixers comprise helical mixing elements as described e.g. in U.S. Pat. No. 5,609,271 to the applicant of the present invention. In this concept, the two substances are mixed with each other by repeated shifting. In order to achieve a high quality of the mixture, different parameters of the mixers are dimensioned in various ways, e.g. the geometry of the mixing element, the number of mixing elements, and the mixer diameter. In mixers of the static type, a laminar flow is generally assumed for media having medium to high viscosities. This is also the case in mixers having very small diameters of e.g. 1 to 2 mm and components having low viscosities.

Especially if the quantities to be mixed are very small, e.g. in the case of dropwise dispensing, the use of mixers having conventional mixing elements is problematic as a sufficiently thorough mixing effect, particularly of components having different viscosities respectively surface tensions, can no longer be achieved. Especially in medical applications, this may lead to important problems.

Furthermore, mixers having disk-shaped mixing elements with one aperture or a plurality of apertures are known in the art.

GB-A-1,188,516 discloses a mixer having a stack of disks that are arranged in the mixer housing and have respective apertures, the disks being arranged in such a manner that the apertures are mutually rotationally offset by 180°.

U.S. Pat. No. 2,125,245 discloses an emulsion apparatus with plates that are arranged in a housing and each of which has either a plurality of small openings or a larger opening.

U.S. Pat. No. 5,968,018 discloses a cell separation device with a stack of disks having each an orifice, the disks being arranged such that the orifices are mutually rotationally offset by 180°.

US-A1-2003/0179648 discloses a mixer having mixing chambers between which conventional mixing helixes may be arranged, inter alia.

U.S. Pat. No. 4,068,830 discloses a conventional mixer with mixing helixes and perforated plates arranged therebetween.

In none of these mixers a small dispensing volume is addressed.

### SUMMARY OF THE INVENTION

On the background of this prior art, it is an object of the present invention to provide a mixer with mixing elements that ensures a thorough mixture of the two substances also with very small dispensing volumes. This object is attained with a static mixer wherein at least one group comprising at least two mixing elements in the form of disk-shaped shear plates is additionally provided whose disks each have at least one passage.

### BRIEF DESCRIPTION OF THE DRAWINGS

The invention will be explained in more detail hereinafter with reference to drawings of an exemplary embodiment.

FIG. 1 shows a sectional view of a mixer according to the invention,

FIG. 2 shows an enlarged detail of FIG. 1,

FIG. 3 shows a top view of FIG. 2,

FIG. 4 shows a perspective view of the mixing elements of FIG. 1, and

FIG. 5 schematically shows an embodiment variant.

### DETAILED DESCRIPTION OF THE INVENTION

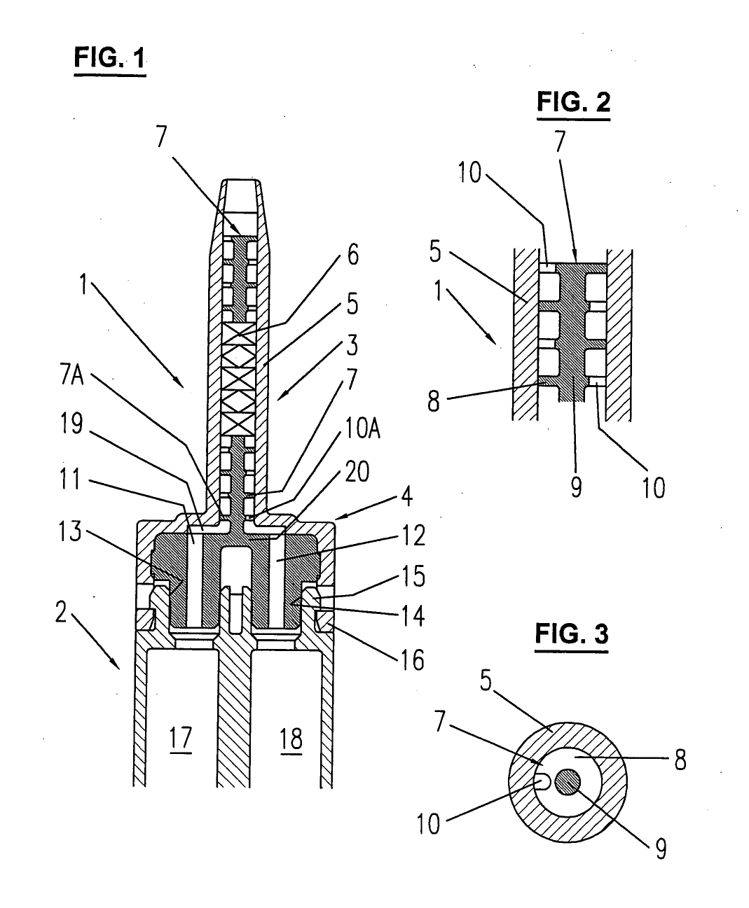

FIG. 1 shows a longitudinal section of a mixer 1 according to the invention that is fastened to a two-component cartridge 2 and has a housing 3 with an inlet section 4. In cylindrical housing portion 5, mixing elements of different kinds are arranged. In the middle section of the mixing elements, a conventional mixing helix 6 is arranged that is followed on both sides by novel mixing elements 7, see also FIGS. 2 and 3.

The novel mixing element 7 is designed as a shear plate and comprises a disk 8 that is fastened to a hub 9 and has a passage 10. As appears particularly in FIG. 2, passages 10 are arranged in positions that are each rotationally offset with respect to the following element, e.g. by 180°. The shape of the passages is chosen such that the liquids are subjected to a higher velocity or shearing stress, respectively, thereby forming subsequent vortices and ensuring a better mixture even of smallest quantities. However, the particular shape is not restricted to the depicted shape and may differ therefrom.

After the shearing and whirling action exerted by a number of shear plates, a mixing process through shifting starts in the following conventional mixing helixes in order to achieve the best possible dispersion of the components over the cross-section.

In the exemplary embodiment according to FIG. 1, as seen from the inlet, four shear plates are followed by five conventional mixing helixes that are again followed by four shear plates. In FIG. 5, another order is illustrated where e.g. five helixes are followed by four shear plates and then again by five mixing helixes. These two exemplary embodiments are meant to indicate that mixing helixes and shear plates may be combined as desired so that a mixer can be optimally adapted to the materials that are to be mixed and to the geometrical situation.

In its inlet section 4, the mixer comprises two inlets 11 and 12 which in this exemplary embodiment are pushed into outlets 13 and 14 of cartridge 2. Mixer inlet section 4 further comprises locking elements 15 on the cartridge and corresponding locking elements 16 on the mixer inlet section. The locking elements may also be of the bayonet type.

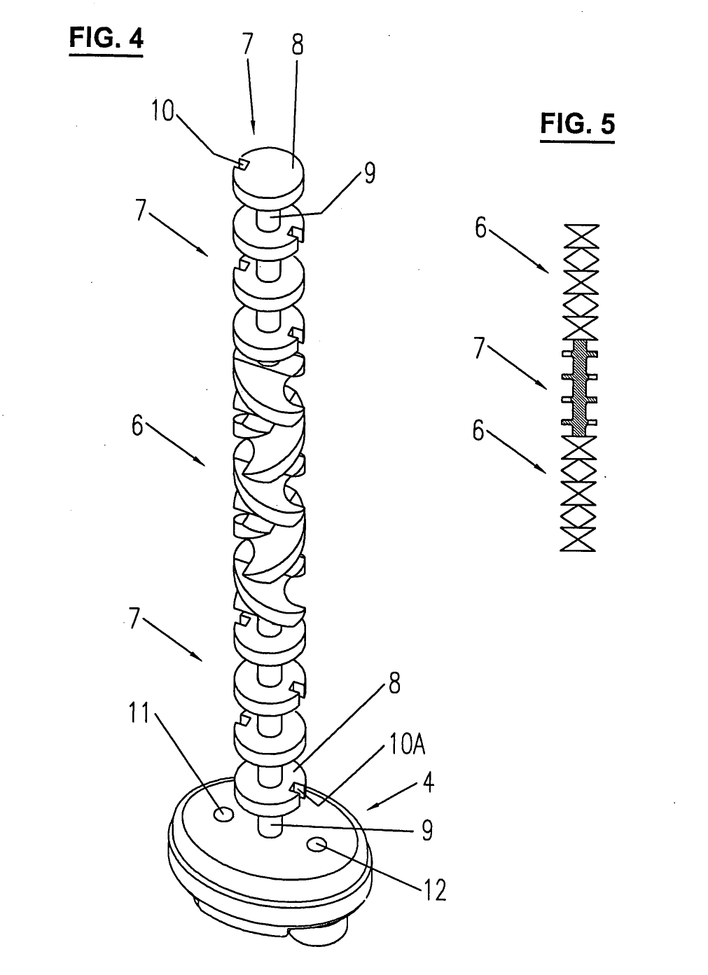

In FIG. 4, the different mixing elements are illustrated in a perspective view where shear plates 7 with their passages 10 and conventional helix 6 are recognized. In FIG. 4 it is visible that in this example, plate passage 10A of first shear plate 7A is aligned with the outlet openings of inlets 11 and 12. Thus, the longitudinal axis of shear plate passage 10 substantially coincides with the connecting line of the two inlet outlet openings. However, the orientation of the longitudinal axis of the shear plate passage with respect to the outlets may also be different, e.g. perpendicular thereto.

It is further shown that the mixer inlet section is connected to the mixing elements by a connecting member 20 and can be produced integrally therewith in one piece.

The two substances from the two storage containers 17 and 18 of cartridge 2 are transferred to the mixer inlet under pressure. In space 19 between connecting member 20 and the first shear plate, the two substances meet and are jointly pressed through passage 10A of shear plate 7A. The shape of the shear plate passage influences the shearing stress respectively the formation of vortices and may provide a better mixture of the two substances.

As has been pointed out in the introduction, mixing plates with suitable passages can be suitably used for mixing media having different viscosities, especially if very small quantities are to be dispensed drop by drop. More specifically, the diameter of the mixing elements may be of the order of about 1 mm.

The invention, i.e. the provision of shear plates, is not limited to the exemplary cylindrical shape. Both the mixer housing, respectively its hollow portion receiving the mixing elements, and the mixing elements and shear plates may have other shapes and cross-sections, e.g. rectangular or square ones. Also, a shear plate may comprise more than one shear plate passage and the shape of the latter may e.g. be round, oval, or cuneiform, rectangular, or triangular.

What is claimed is:

1. A static mixer for two components, comprising a housing with an inlet section and mixing elements that are arranged in the housing, of which at least one mixing element is a mixing helix, wherein at least one group comprising at least two mixing elements in the form of disk-shaped shear plates is additionally provided whose disks each have at least one passage.

2. A static mixer according to claim 1, wherein the mixer housing comprises a group of shear plates, the passage or passages of each successive shear plate being mutually rotationally offset by an angle.

3. A static mixer according to claim 2, wherein the angle is equal to 180°.

4. A static mixer according to claim 2, wherein groups of shear plates and of mixing helixes follow each other alternately.

5. A static mixer according to claim 1, wherein the passage of the first shear plate on the inlet side is aligned with the mixer inlet outlet openings, the longitudinal axis of the shear plate passage substantially coinciding with the connecting line between the two inlet outlet openings or being perpendicular thereto.
